(19) United States
(12) Patent Application Publication
(10) Pub. No.: US 2008/0264579 A1
(43) Pub. Date: Oct. 30, 2008

(54) TRACK REINFORCEMENT FOR SECTIONAL DOORS

(75) Inventors: Michael G. Rauch, Abbotsford (CA); James A. Letkemann, Abbotsford (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: HELTON INDUSTRIES LTD., Abbotsford, BC (CA)

(21) Appl. No.: 12/110,080

(22) Filed: Apr. 25, 2008

Related U.S. Application Data
(60) Provisional application No. 60/913,873, filed on Apr. 25, 2007.

(51) Int. Cl. E05D 15/52

(52) U.S. Cl. 160/202; 160/201

(57) ABSTRACT

A load-bearing reinforcement member for fastening to the horizontal portion of a track for a sectional door system, which, when fastened to a horizontal portion of the track, results in a reinforced track structure having one, two or more enclosed spaces along the length of the reinforced portion of the track structure.

### REFERENCE TO RELATED APPLICATION

This application claims the benefit of the filing date of U.S. provisional patent application No. 60/913,873 filed on 25 Apr. 2007 and entitled “TRACK REINFORCEMENT FOR SECTIONAL DOORS”, which is hereby incorporated by reference herein.

### TECHNICAL FIELD

The present invention relates to track assemblies for sectional doors. More particularly the present invention relates to track structures for guiding and supporting rollers on a sectional door for movement of the door between closed and open positions.

### BACKGROUND

Upward acting sectional doors commonly include hinges or other brackets to hold rollers in place on each side of each door, which in turn are guided on a track on each side of each door. The side of the track which receives the rollers is referred to herein as the “inner” side, and the opposite side is referred to herein as the “outer” side. Each track has a vertical, transitional curvilinear, and horizontal portion. As the door moves from the closed position to the open position these rollers transfer the weight of the door from the vertical portion of the track through the transitional curvilinear portion and onto the horizontal portion of the track. The horizontal portion of the track requires reinforcement in order to ensure that it remains rigid during dynamic loading while the door is opening and during static loading while the door is at rest in the open position. Upward acting sectional doors predominantly exert vertical loads through their rollers onto the horizontal portion of the track assembly. As a result, the horizontal portion of the track deflects downward in a vertical plane throughout its span. Furthermore, due to the shape of the track cross-section and supporting members, there is a tendency for the horizontal portion of the track to “bow” i.e. to exhibit angular deflection, and to deflect in a horizontal direction.

Conventional horizontal track assemblies are typically comprised of a horizontal portion of a track and a reinforcement in the form of a horizontal angle bracket. As shown in FIGS. 8 and 9, the horizontal angle bracket reinforcement is a linear part of varying lengths that has two legs of equal or unequal width. One leg of the horizontal angle bracket reinforcement is attached to the outer side of the track, and the other leg of the horizontal angle bracket reinforcement protrudes outward from the track at a right angle to the opposing leg. The protruding leg of the angle bracket reinforcement is typically oriented outwardly from the lower side of the track or the upper side of the track depending on the assembly configuration. The bottom of the curvilinear portion of the track is commonly attached to a header bracket on a wall whereas the linear horizontal portion of the track may be attached to a back hang attached to a ceiling at any intermediate point along its length. FIGS. 8 and 9 illustrate mounting members for each track consisting of a header bracket to attach the curvilinear portion of the track to a wall and a back hang to attach the horizontal portion of the track to the ceiling. In the prior art example shown in FIG. 9, an extra mounting bracket is required to attach the back hang to the top of the horizontal portion of the track and/or the top of the horizontal angle bracket reinforcement.

Conventional horizontal angle bracket reinforcements are poorly designed to accommodate the stresses applied by an upward acting sectional door. Horizontal angle bracket reinforcements displace a considerable amount of material from the center of gravity in the horizontal direction, thereby increasing their resistance to horizontal deflection; however, the majority of load applied by a sectional door is vertical. This causes the track to “wobble” during dynamic loading (while the door moves from the closed position to the open position), and to sag during static loading (while the track is at rest in the open position). Also, by fastening the horizontal angle bracket reinforcement to the outer (and consequently heavier) side of the track, the reinforcement translates the center of gravity horizontally away from the point of load application. This provides a greater moment arm for the vertical load, producing additional angular deflection. Angular deflection is of particular concern because in most conventional track assemblies, the center of gravity is located near the top surface of the track between the track and the horizontal angle bracket reinforcement, and the rotation about that point results in the relevant horizontal deflection. Furthermore, large angular deflection can contribute to track “roll-out” by giving the vertical load a larger moment arm over the bottom portion of the track profile. Track roll-out is a certain type of failure known within the upward acting sectional door industry in which the curved portion of the horizontal cross-section of the track bends downwards and allows the roller to literally roll out of the track. Also, aside from promoting failure mechanisms in the track assembly, excessive deflection in any direction may make the installer or user of the door uncomfortable with its performance and cause them to replace the track set with a heavier and more costly assembly.

Conventional horizontal angle bracket reinforcements are currently made in heavy gauges due to the performance issues listed in the previous paragraphs. In order to increase the stiffness and compensate for the deficiencies in the system, the thickness of the reinforcement is increased in order to increase the moment of inertia in all directions.

Due to the listed deficiencies in conventional methods for reinforcing horizontal portions of tracks in upward acting sectional door assemblies, there exists a need within the industry for a reinforcement member that is stiffer than the conventional reinforcement. Furthermore, an improved horizontal track assembly should be highly manufacturable and cost effective to produce when compared to the conventional horizontal track.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

A horizontal track reinforcement according to an embodiment of the present invention better resists horizontal, vertical, and angular deflection than conventional horizontal angle bracket reinforcements in applications relating to horizontal track assemblies in upward acting sectional door installations. Furthermore, a track reinforcement according to an embodiment of the present invention provides a material savings over the conventional reinforcements and has the ability to be easily manufactured.

Broadly, an embodiment of the present invention relates to a load-bearing horizontal reinforcement member for horizontal portions of a track that creates one, two, or more enclosed spaces with the horizontal portion of the track at any section or makes one, two, or more enclosed spaces in its own geometry and is attached to the track at any section. The enclosure efficiently displaces material from the center of gravity, thereby increasing the moment of inertia and the resistance to deflection under a given load. By increasing the stiffness of the assembly, it follows that the reinforcement will be less likely to permit grinding of track rollers against the track due to deflection of the track, wobbling due to dynamic loading of the track, sagging due to static loading of the track, and rolling-out due to angular deflection of the track. Also, the reinforcement is able to offer performance advantages such as these over the conventional systems while providing a material savings over conventional systems. The profile of the reinforcement is fastened to the profile of the track in one, two, or more places by any suitable means, including but not limited to riveting, welding, bolting, clipping, folding, or any combinations of these methods.

The reinforcement may permit direct attachment of the reinforcement to the header bracket. Alternatively, a reinforcement according to an embodiment of the present invention may be used in conjunction with a conventional horizontal angle bracket of some length or any other mounting bracket in order to provide alternative means for attaching the horizontal portion of the track to the header bracket. The horizontal angle bracket may be fastened to the horizontal portion of the track by any suitable method, including but not limited to those methods mentioned above, for attaching the reinforcement to the horizontal portion of the track. However, in some cases this embodiment of the present invention will include slots near the front of the profile that will allow the assembly to attach to the header bracket.

Furthermore, because of the improvements made by the design, this embodiment of the present invention will require less material while being stiffer than the conventional horizontal angle bracket reinforcement. The reinforcement aims to simultaneously achieve all of the functional requirements of the part in the horizontal track assembly.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

Further aspects and embodiments of the invention will become more readily apparent to those skilled in the art from the following description when taken in conjunction with the accompanying drawings, in which like reference numerals have been used in different figures to indicate like parts and in which:

FIG. 1 shows a perspective view from the interior of a sectional door assembly featuring a horizontal portion of a track having a reinforcement according to an embodiment of the invention, and using a separate horizontal angle bracket to attach to the header bracket.

FIGS. 2A and 2B show side views of the sectional door assembly of FIG. 1, with FIG. 2A illustrating an embodiment where the track reinforcement runs along the entire length of the horizontal portion of the track, and FIG. 2B illustrating an embodiment where the track reinforcement runs along a discrete portion of the horizontal portion of the track.

FIGS. 3A and 3B show detailed views of the attachment between the horizontal portion of the track of FIG. 1 and the header bracket showing how the separate horizontal angle bracket attaches the track to the header bracket, with FIG. 3A illustrating an embodiment where the horizontal angle bracket includes holes for attaching the horizontal angle bracket to the track, and FIG. 3B illustrating an embodiment where the horizontal angle bracket includes slots for attaching the horizontal angle bracket to the track.

FIG. 4 shows a section view of the profile of the track and the profile of a track reinforcement according to an embodiment of the invention.

FIG. 5 shows a perspective view from the interior of a sectional door assembly featuring a horizontal portion of a track having a reinforcement that attaches directly to the header bracket according to an embodiment of the invention.

FIG. 6 shows a detailed view of the attachment between the horizontal portion of the track of FIG. 5 and the header bracket showing how the track reinforcement attaches directly to the header bracket.

FIGS. 7A-X show section views of profiles of track reinforcements according to other embodiments of the invention.

FIGS. 8 and 9 show perspective views from the interiors of sectional door assemblies featuring conventional horizontal angle brackets as track reinforcements according to the prior art.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

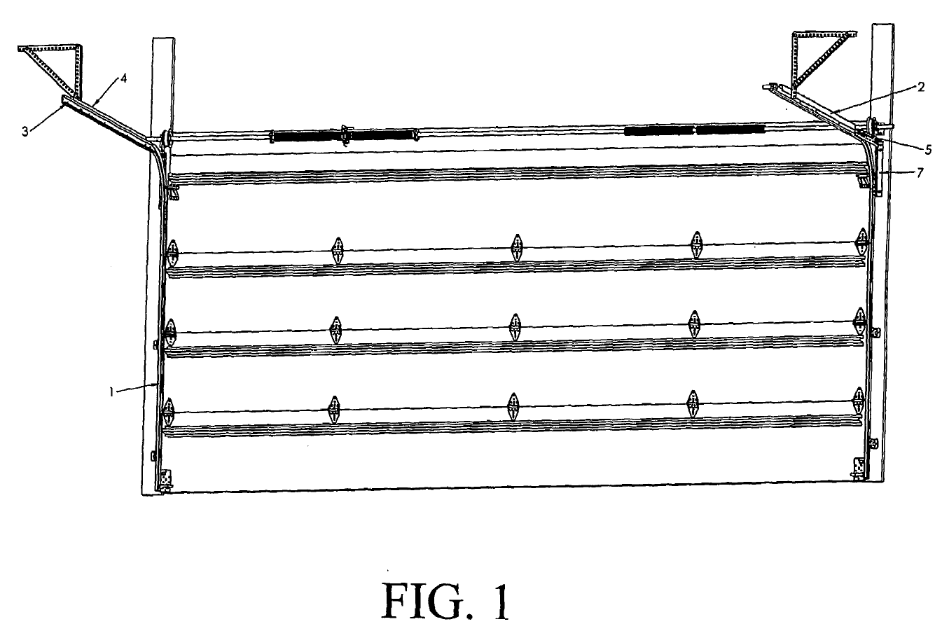

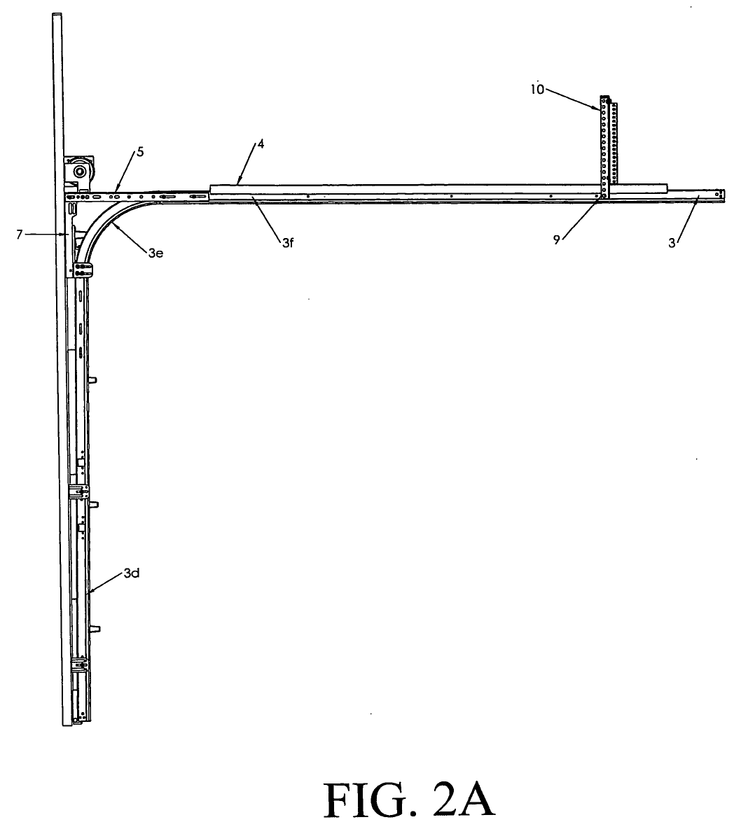

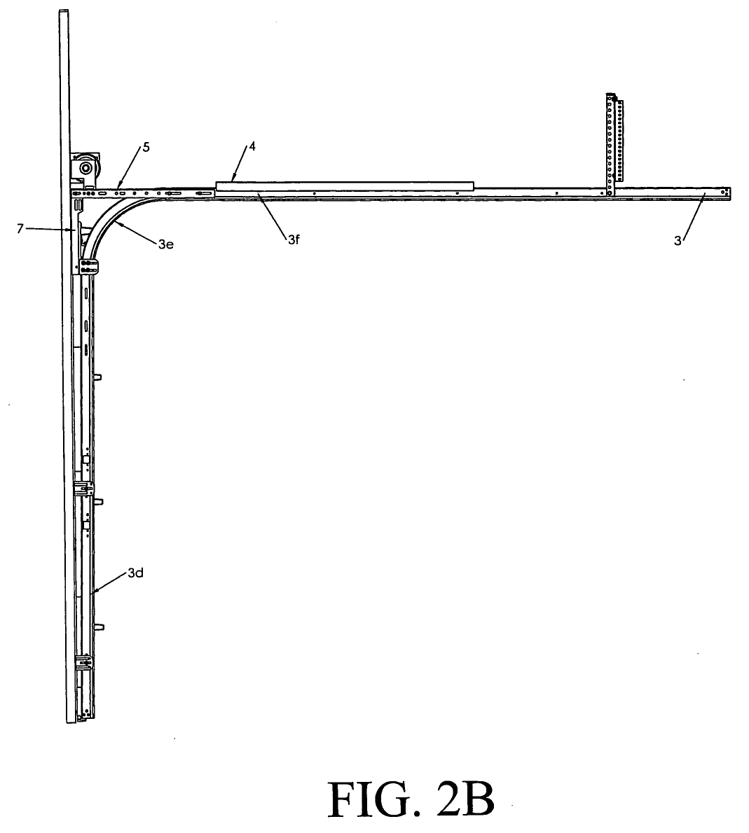

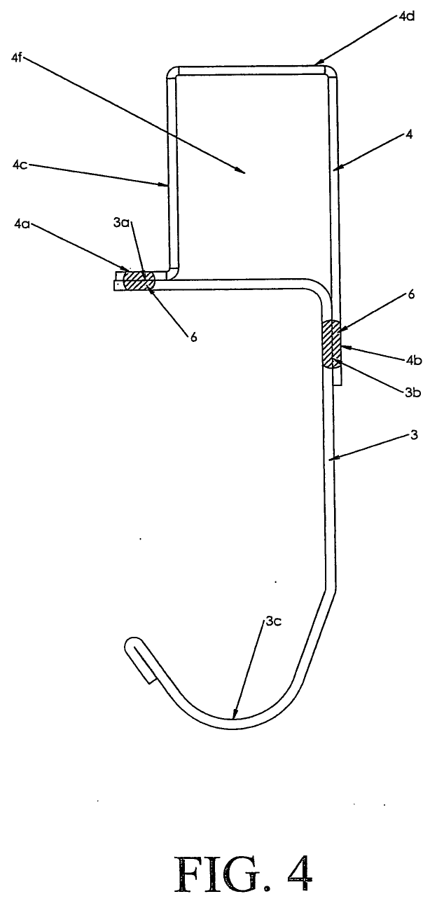

As shown in FIG. 1 and FIGS. 2A and 2B, an upward acting sectional door assembly 1 has a track 3 which includes a vertical portion 3d, a curvilinear portion 3e and a horizontal portion 3f. When the sectional door is in a closed position, the rollers attached to sections of the door are primarily in the vertical portion 3d of the track 3. As the door moves from the closed position to the open position, the rollers move through the track 3 from the vertical portion 3d through the curvilinear portion 3e to the horizontal portion 3f. The term “vertical” used in this document is not limited to things that are precisely vertical and the term “horizontal” used in this document is not limited to things that are precisely horizontal. “Vertical” encompasses situations where something is substantially vertical but departs from precise verticality by a few degrees in either direction, and “horizontal” encompasses situations where something is substantially horizontal but departs from precise horizontality by a few degrees in either direction. Referring to the cross-sectional view of the track 3 in FIG. 4, the track 3 has a top side 3a, outer side 3b and bottom side 3c.

In the embodiment shown in FIGS. 1-4, the horizontal portion 3f of the track 3 is reinforced with a track reinforcement 4 to form a reinforced track structure 2. Depending on the configuration, the structure of the track 3 may also include an angle bracket 5 to attach the track 3 to a header bracket 7 on a wall.

As shown in FIG. 4, the track reinforcement 4 attaches to the track 3 at conjoined surfaces on top side 3a and outer side 3b of track 3 in order to create an enclosed space 4f with the track 3. In the embodiment in FIG. 4, the track reinforcement 4 includes a short horizontal leg 4a that rests on top of the horizontal portion 3f of the track 3 near its top side 3a, a vertical leg 4c that extends substantially perpendicularly from the horizontal leg 4a away from the top side 3a, a second horizontal leg 4d that extends substantially perpendicularly from the vertical leg 4c in the direction of the outer side 3b of track 3, and a second vertical leg 4b that extends from the second horizontal leg 4d in the direction of the bottom side 3c of track 3 and coincident to the outer side 3b. The horizontal leg 4a and the second vertical leg 4b of the track reinforcement 4 coincide with the top side 3a and the outer side 3b of the horizontal portion 3f of the track 3 respectively in order to provide means for fastening track reinforcement 4 to track 3. In the embodiment illustrated in FIG. 4, spot welds 6 are used to secure the track reinforcement 4 at various points along its length to the horizontal portion 3f of the track 3. The result is an enclosure defining an enclosed space 4f near the horizontal portion 3f of the track 3 that displaces the materials of the track reinforcement 4 from the center of gravity of the reinforced track structure 2.

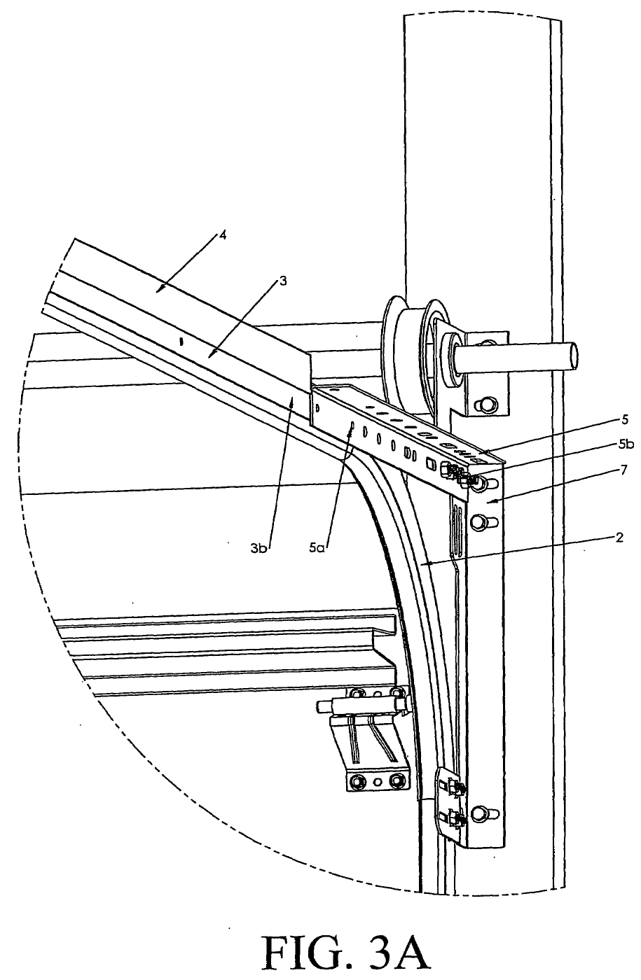

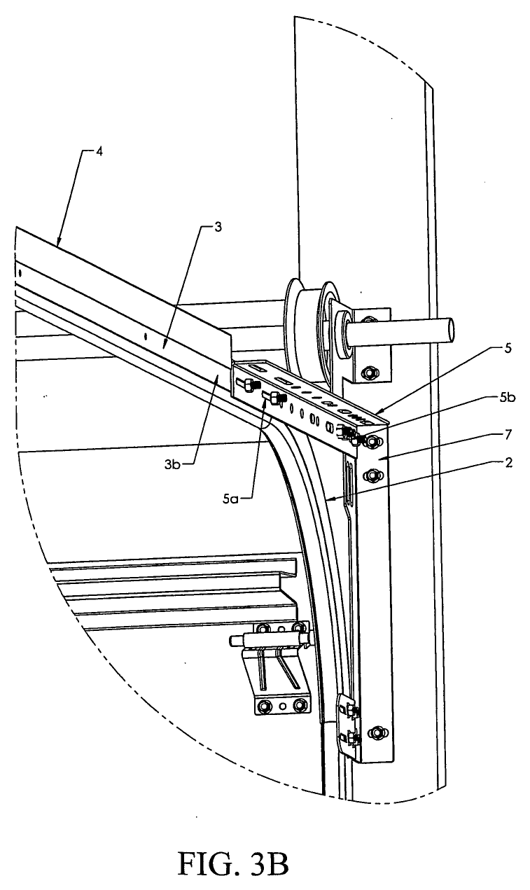

In the embodiments shown in FIGS. 2A and 2B, the track reinforcement 4 begins near the curvilinear portion 3e of the track 3, and runs along the linear horizontal portion 3f of the track 3. The assembly 1 includes a conventional angle bracket 5 in the embodiments shown in FIGS. 2A and 2B for attaching to the header bracket 7. In other embodiments, the assembly 1 may include any other mounting bracket that allows the assembly 1 to attach to the header bracket 7. As shown in FIGS. 3A and 3B, the conventional angle bracket 5 includes holes or slots 5a in a rear portion thereof that allow the angle bracket 5 to be fastened to the outer side 3b of the horizontal portion 3f of the track 3, and also includes holes or slots 5b in a front portion thereof that allow the angle bracket 5 to fasten to the header bracket 7. In embodiments where slots 5a are defined in the rear portion of angle bracket 5, the position of angle bracket 5 with respect to track 3 may be adjusted fore and aft to accommodate sectional doors having different thicknesses.

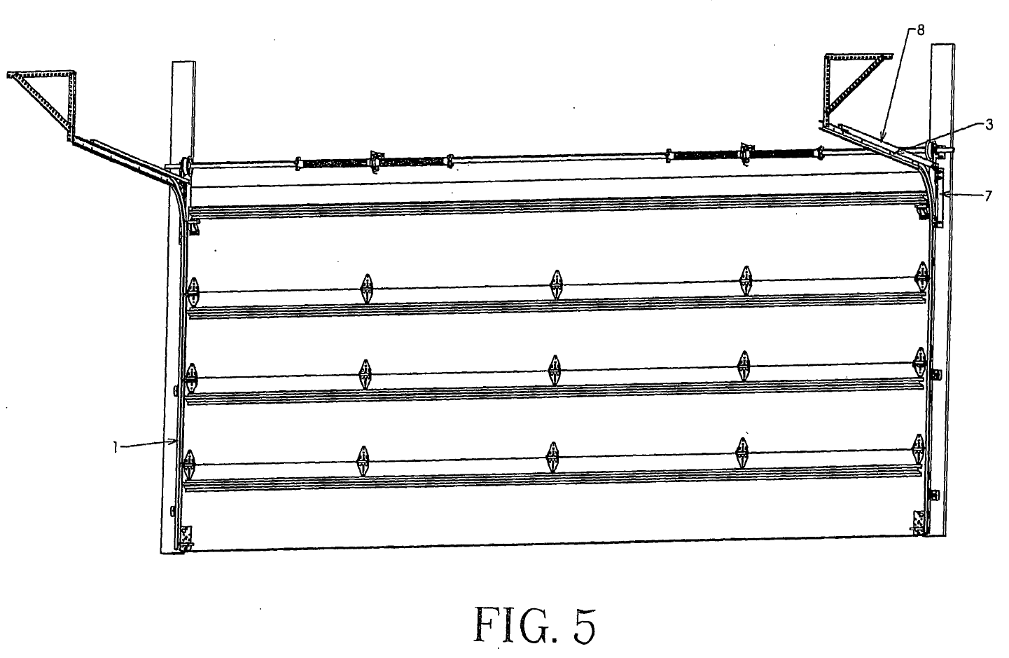

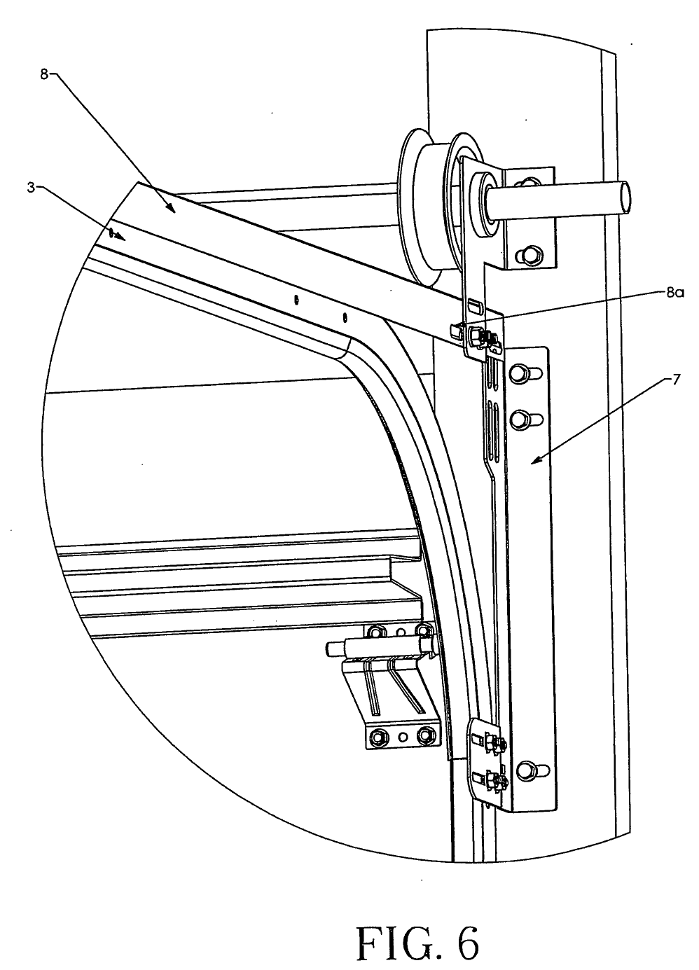

In the embodiment shown in FIG. 5 and FIG. 6, the track reinforcement 8 is the same as track reinforcement 4 in FIGS. 1-4, except for the fact that the track reinforcement 8 is also constructed with means to attach directly to the header bracket 7, thereby avoiding the need for an additional angle bracket such as angle bracket 5 in the embodiments of FIGS. 1-4. The track reinforcement 8 includes holes or slots 8a that allow the track reinforcement 8 to attach directly to the header bracket 7. In this embodiment, the assembly 1 does not include any form of conventional angle bracket. This configuration is advantageous because it only requires the attachment of the track reinforcement 8 to the horizontal portion 3f of the track 3 during assembly, and it further capitalizes on the material savings provided by the track assembly 1.

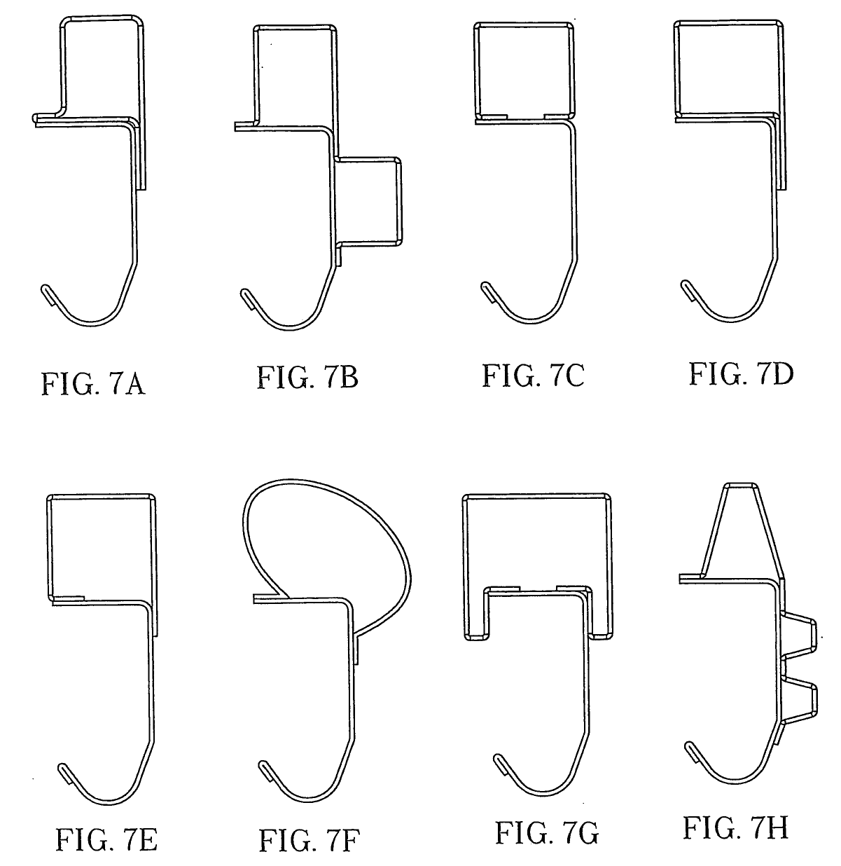

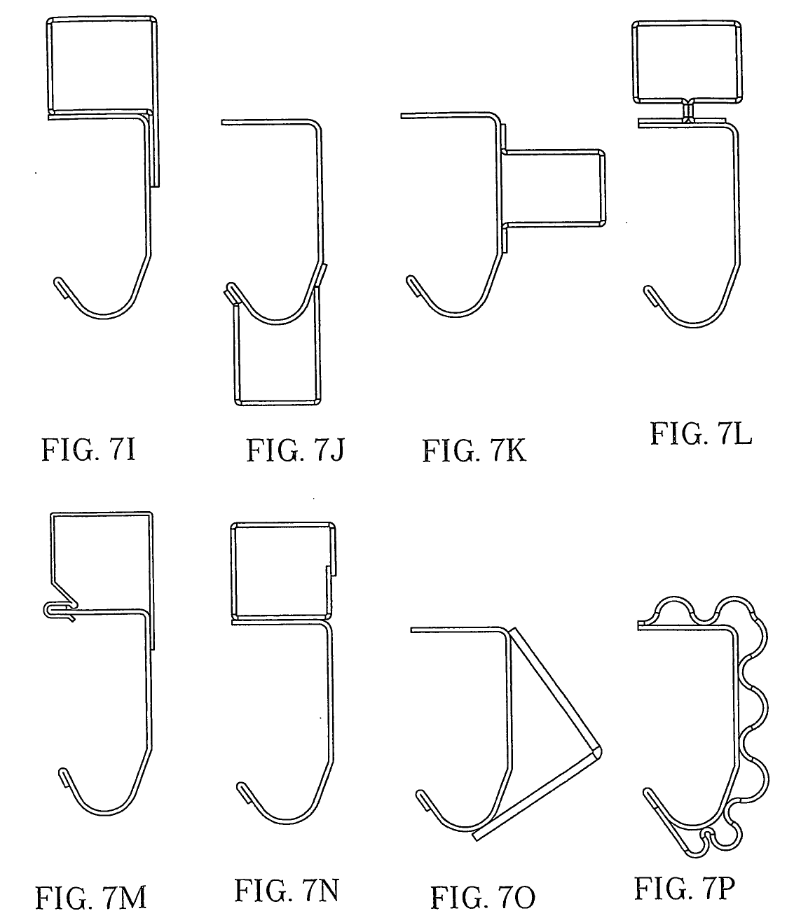

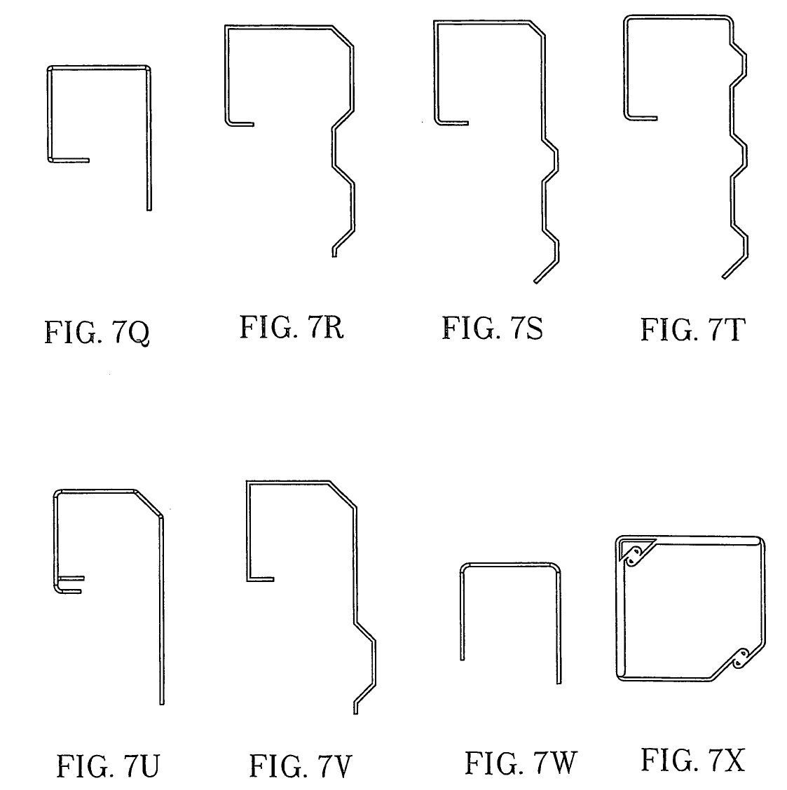

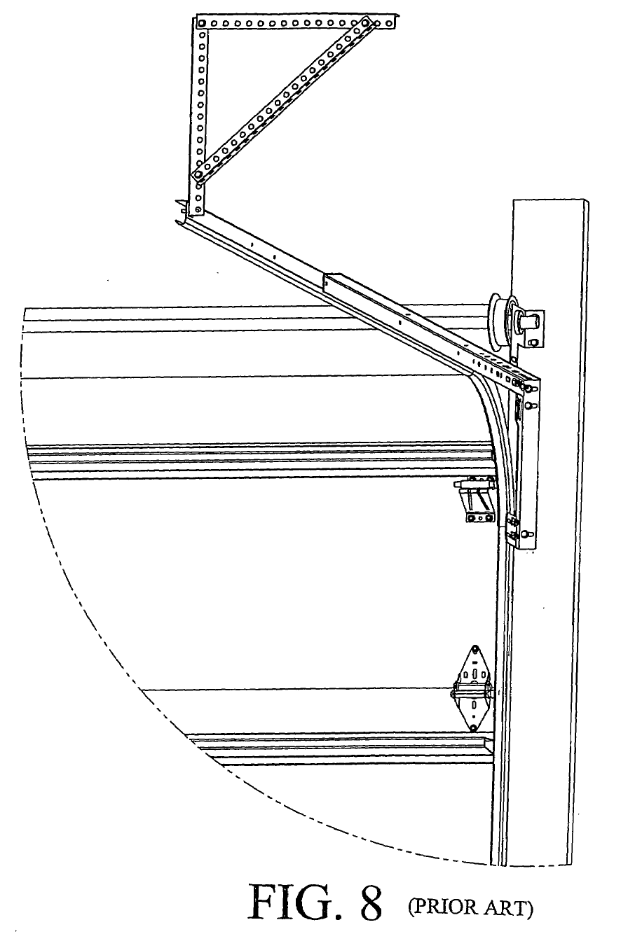

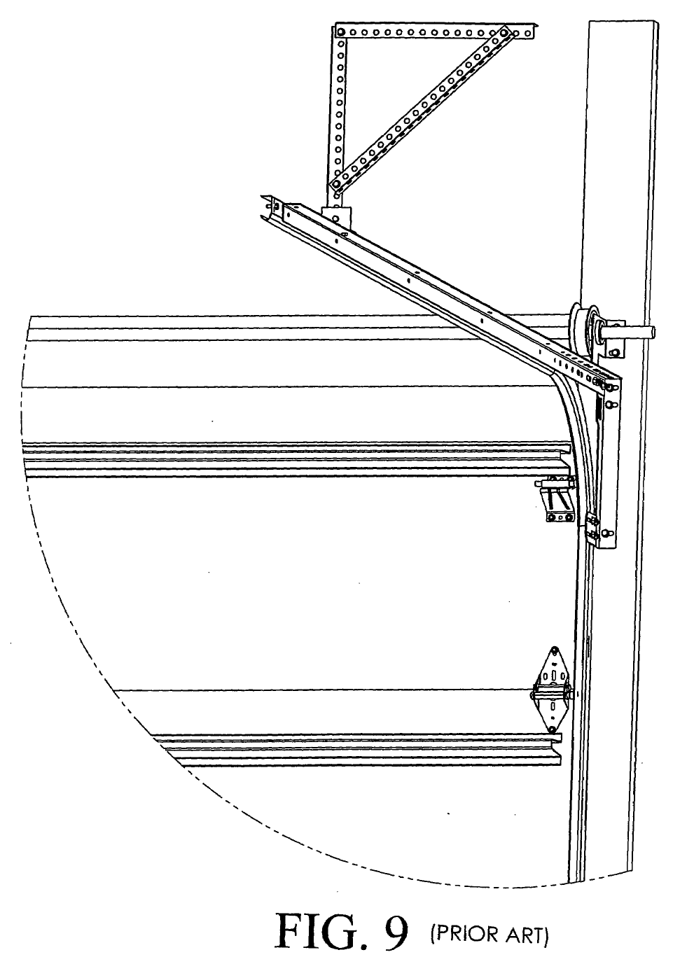

FIGS. 7 A-X show cross-sectional views of various examples of alternative configurations for track reinforcements that can be applied to the track 3. FIGS. 7A-P show track reinforcements applied to the track 3, and FIGS. 7Q-X show track reinforcements alone. It is notable that the reinforcements either make one, two or more enclosures with the track 3 in the manner that it is fastened, or makes one, two or more enclosures on its own and is fastened externally to the track 3. As will be apparent to those skilled in the art, there is no limit to alternative configurations that create enclosures defining one, two or more enclosed spaces 4f according to the invention.

The track reinforcement 4, 8 can run along the entire length of the horizontal portion 3f of the track 3, as illustrated in FIG. 2A, or run along only one or more discrete portions of the horizontal portion 3f, as illustrated in FIG. 2B.

As shown in FIGS. 2A and 2B, the reinforced track structure 2 may be supported from the ceiling by a back hang bracket 10, which may be attached using a slot 9 defined in the track 3. In embodiments where the profile of track reinforcement 4,8 has an outer side that is generally parallel with the outer side 3b of track 3 and does not extend significantly outwardly from the outer side 3b of track 3 when attached thereto, the back hang bracket 10 may be attached to the horizontal portion 3f of track 3 at a location where track reinforcement 4, 8 runs along track 3, as shown in FIGS. 1 and 2A.

Alternative embodiments can be constructed by changing any of the listed fastening procedures in the assembly to spot welding or any other kind of welding, riveting, bolting, folding, clipping or any other fastening mechanism, changing the number of fasteners required at any given section, or changing the spacing of the fastening mechanisms. Alternatively, track 3 could be manufactured with a horizontal portion 3f already reinforced at the outset with enclosures defining one, two or more enclosed spaces 4f as described above in respect of track reinforcement 4, 8, without the need for a separately-manufactured reinforcement member 4, 8 to be subsequently attached to the horizontal portion 3f.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A load-bearing reinforcement member for fastening to the horizontal portion of a track for a sectional door system, which, when fastened to a horizontal portion of the track, results in a reinforced track structure having one, two or more enclosed spaces along the length of the reinforced portion of the track structure.

2. A load-bearing reinforcement member according to claim 1 having a profile with an outer side that is generally parallel with an outer side of the track and does not extend significantly outwardly from the outer side of the track when the reinforcement member is attached to the track.

3. A load-bearing reinforcement member according to claim 1 wherein at least one of the one, two or more enclosed spaces is located above the track when the reinforced track structure is installed.

4. A load-bearing reinforcement member according to claim 1 wherein the load-bearing reinforcement member is configured to extend forward beyond the horizontal portion of the track for attaching directly to a header bracket mounted to a wall.

5. A load-bearing reinforcement member according to claim 4 wherein one or more slots are defined in a front portion of the load-bearing reinforcement member for facilitating attachment to the header bracket.

6. A reinforced track structure for a sectional door system, the reinforced track structure comprising a separate load-bearing reinforcement member fastened to a horizontal portion of a track, resulting in one, two or more enclosed spaces along the length of the reinforced portion of the track structure.

7. A reinforced track structure according to claim 6 wherein the load-bearing reinforcement member has a profile with an outer side that is generally parallel with an outer side of the track and does not extend significantly outwardly from the outer side of the track when the reinforcement member is attached to the track.

8. A reinforced track structure according to claim 7 wherein the track defines a back hang slot therein for attaching a back hang bracket thereto, the back hang slot located along the reinforced portion of the track structure.

9. A reinforced track structure according to claim 6 wherein the load-bearing reinforcement member is configured to extend forward beyond the horizontal portion of the track for attaching directly to a header bracket mounted to a wall.

10. A reinforced track structure according to claim 9 wherein one or more slots are defined in a front portion of the load-bearing reinforcement member for facilitating attachment of the load-bearing reinforcement member to the header bracket.

11. A reinforced track structure according to claim 6 comprising an angle bracket attached to the track at a location in front of the load-bearing reinforcement member, the angle bracket configured to extend forward beyond the horizontal portion of the track for attaching directly to a header bracket mounted to a wall.

12. A reinforced track structure according to claim 11 wherein one or more slots are defined in a front portion of the angle bracket for facilitating attachment of the angle bracket to the header bracket.

13. A reinforced track structure according to claim 11 wherein one or more slots are defined in a rear portion of the angle bracket for facilitating attachment of the angle bracket to the track and for allowing the position of the angle bracket with respect to the track to be adjusted fore and aft to accommodate sectional doors having different thicknesses.

14. A reinforced track structure according to claim 6 wherein at least one of the one, two or more enclosed spaces is located above the track when the reinforced track structure is installed.

15. A reinforced track structure for a sectional door system, wherein a horizontal portion of a track is reinforced with a load-bearing reinforcement portion integral to the track and defining one, two or more enclosed spaces along the length of the reinforced portion of the track structure.

16. A method of reinforcing a track structure for a sectional door system, comprising reinforcing each track of the sectional door system with a separate load-bearing reinforcement member or integral reinforcement portion, each defining one, two or more enclosed spaces along the length of the reinforced portion of the track structure.
